(19) United States
(12) Patent Application Publication
(10) Pub. No.: US 2011/0244555 A1
(43) Pub. Date: Oct. 6, 2011

(54) METHOD AND SYSTEM FOR PURIFYING RAW GASES, PARTICULARLY BIOGAS, FOR OBTAINING METHANE

(75) Inventor: Lothar Günther, Geretsried (DE)

(73) Assignee: DGE DR.-ING. GUENTHER ENGINEERING GMBH, WITTENBERG (DE)

(21) Appl. No.: 13/132,659

(22) PCT Filed: Nov. 28, 2009
(86) PCT No.: PCT/EP2009/008487

§ 371 Date: Jun. 21, 2011

(30) Foreign Application Priority Data
Dec. 3, 2008 (DE) 10 2008 060 310.4

(51) Int. Cl. C12S 5/00; B01D 53/14

(52) U.S. Cl. 435/266; 95/170; 95/160; 95/161; 96/202

(57) ABSTRACT

In a method for purifying biogas, components present in the biogas, such as carbon dioxide, sulfur compounds and ammonia, are separated in a plurality of different process stages. The method is characterized by low energy consumption and an increase in methane concentration of at least 10% while keeping methane losses low. In a first purifying step, carbon dioxide, hydrogen sulfide, ammonia and other organic water-soluble substances in the raw gas are removed at normal pressure or at overpressure of up to 6 bar in a wash column using fresh water, methane gas having a methane concentration of at least 65% is withdrawn at the head of the wash column. Methane and carbon dioxide dissolved in the washing water are sequentially separated from the contaminated washing water discharged from the washing stage in a first stripping column at normal pressure and subsequently in a second stripping column in a vacuum.

The invention relates to a method of purifying raw gases, especially biogas, for obtaining methane in which the components contained in the raw gas or biogas such as carbon dioxide, sulfur compounds and ammonia are separated in a plurality of different process steps, and to a suitable system for carrying out the method.

Biogas is formed by the anaerobic (oxygen-free) digestion of organic material and is used as a renewable energy source. The gases produced are classified as sewage gas, digester gas, landfill gas and biogas, depending on the respective raw materials used, such as sewage sludge, slurry, manure, waste material of vegetable or animal origin and biological raw materials. References to biogas are henceforth to be taken to include all the above-mentioned gases.

Raw gases include gases whose main components are CH₄ and CO₂ such as methane gas or flare gas (associated gas).

The main components of biogases are methane and carbon dioxide as well as minor components such as nitrogen, sulfur compounds, oxygen, hydrogen and ammonia. To further utilize the methane contained in the biogas it is therefore necessary to process the biogas in a plurality of stages in order remove the unwanted components.

The usual process steps per se, which are as a rule carried out separately, comprise dehumidification (removal of water), desulfurization and the removal of carbon dioxide and ammonia.

Biological methods (using microorganisms) as well as chemical adsorption methods of desulfurization are known in which the hydrogen sulfide is converted to elemental sulfur in various ways.

Carbon dioxide as well as small amounts of hydrogen sulfide is removed (by physical or chemical means), for example by pressure water scrubbing, membrane processes, the Selexol process (under high pressure), pressure swing adsorption or amine scrubbing. Some of these methods also enable water or ammonia to be removed as well.

Most of the above-named methods are energy-intensive and lead to methane losses.

Relatively high losses of methane occur with the pressure water scrubbing and pressure swing adsorption methods amounting to approximately 2 to 5% of the methane contained in the biogas. Furthermore, this methane is contained in the carbon dioxide that has been removed and can therefore be used as a fuel only by means of an auxiliary firing system because it is present in such small concentrations. In addition, there are sharp fluctuations in the methane emission with the pressure swing adsorption system owing to its design which have to be smoothed out. Moreover, the raw gas must contain only a very low concentration of H₂S and the disposal required of the activated charcoal used is time-consuming and complicated.

Scrubbing with a scrubbing solution such as an amine scrubbing is then economically justifiable only if the contaminated scrubbing solution is regenerated.

A process is known from DE 10 2005 051 952 B3 for producing methane and liquid carbon dioxide from refinery gas and/or biogas. The raw gas is purified in a preliminary stage (removal of impurities such as NH₃, H₂SO₄, H₂S, SO₂ and COS) and subsequently fed to an absorption column in which the carbon dioxide contained in the raw gas is bound in the scrubbing solution at a pressure preferably of 5 to 30 bar using an amine-containing scrubbing solution. The purified gas accruing contains approximately 98% methane by volume and can be utilized immediately for other purposes. The contaminated scrubbing solution is regeneratively processed in a stripping column under pressure and at increased temperatures (180 to 230° C.).

The method using pressure requires a high level of expenditure on apparatus.

A method is known from WO 2008/034473 A1 of removing methane and carbon dioxide from biogas which makes possible a pressureless removal of carbon dioxide and which produces methane gas with a purity of over 99.5%.

As with all amine scrubbing processes a relatively large amount of energy ranging from 0.5 to 0.8 kWh/Nm³ of biogas is consumed to regenerate the scrubbing solution.

The aim of the invention is to devise a method of purifying raw gas or biogas for obtaining methane that is characterized by low energy consumption and an increase in the methane content of at least 10% with low methane losses. In addition, a system suitable for carrying out the method is to be devised.

The above aim is solved according to the invention by means of the features specified in claim 1. Advantageous embodiments of the method are the subject of claims 2 to 14. The features of a system suitable for carrying out the method are specified in claim 15. Advantageous developments of this system are the subject of claims 16 to 21.

The purification process takes place according to the proposed method in at least three purifying steps which take place in immediate succession to each other, using additive-free fresh water which is circulated in the circuit. Fresh water can be obtained from the local supply network, wells or from rainwater that has undergone treatment. The water used contains no additives. The three purifying steps which it is vital to carry out are as follows:

The raw gas or biogas to be purified, drawn off from a biogas plant or other plant, e.g. a plant for producing digester gas, sewage gas or landfill gas, flows through a scrubbing column with a packed bed under standard pressure or under an overpressure of up to 6 bar in counterflow to the fresh water fed in. In this process carbon dioxide, hydrogen sulfide, ammonia and other organic water-soluble substances contained in the raw gas are bound in the fresh water. Desulfurization of the raw gas or biogas preferably takes place in the first purifying step. Methane gas with a methane content of at least 65% is drawn off at the head of the scrubbing column.

This gas scrubbing is carried out as a rule under standard pressure. In exceptional cases, however, the process can also be operated under overpressure of up to 3 or 4 bars subject to a maximum of 6 bars. At a higher pressure a larger amount of carbon dioxide—up to three times as much at 3 bars—is dissolved in the scrubbing solution. The amount of scrubbing solution required can therefore be reduced by a factor of three and the scrubbing column can be of smaller dimensions because of the smaller gas volume. All conventional compressed gas scrubbing methods require a pressure of over 6 bars in order to produce methane concentrations of over 96% by volume economically. However, a higher pressure leads to significantly higher energy consumption because the system must be subsequently decompressed again. Moreover, higher methane losses occur.

The two purifying steps described below which are carried out by means of stripping columns are vital to ensure that the method is successfully carried out. The contaminated scrubbing solution drawn off from the scrubbing stage is purified in a first stripping column with packed bed or packing under standard pressure on the counterflow principle at temperatures of up to 80° C. with stripping air, stripping air and oxygen or stripping air and carbon dioxide fed in either singly or in combination at amounts varying between 0.1 to 20% based on the amount of gas fed in, with the methane almost completely removed (at least 90%) from the scrubbing solution in which it was dissolved. An oxygenic stripping gas of fuel gas quality is formed in this process as an exhaust gas with the addition of air or oxygen to the scrubbing solution.

The addition of carbon dioxide, preferably obtained from the raw gas, eliminates the need to feed in a carrier gas.

The waste gas formed in the second purifying step can either be returned to the digester of the biogas plant or fed to the methane gas stream removed from the scrubbing stage to enrich the methane content or utilized as a fuel gas.

The first stripping column can also preferably be constructed as a two-stage column with oxygen fed in the first stage and stripping air fed in the second stage, or vice versa, or in combination with carbon dioxide as well. This enables two different fuel gases with different oxygen contents to be produced. The fuel gas, which has a high oxygen content, can, for example, be used as a source of oxygen for a biological desulfurization of the biogas either in the digester or externally.

Alternatively, the fuel gas produced in the circuit can be re-circulated to the digester without feeding in air or oxygen in the case of the carbon dioxide combination.

Fuel gas enriched with CO₂ can also be obtained by adding CO₂. In the third purifying step the contaminated scrubbing solution drawn off from the first stripping column is purified in a second stripping column with a packed bed or packing under vacuum, preferably on the counterflow principle or if necessary on the parallel flow principle, with the carbon dioxide dissolved in the scrubbing solution removed to a residual content of at least of under 300 mg/l.

The pressure for the vacuum should preferably not exceed 0.01 bar. The higher the vacuum the less the residual content of dissolved CO₂ is left in the scrubbing solution. The target residual content of CO₂ is reached at a vacuum of approximately 0.5 bar. The vacuum applied should be at least 100 mbar.

The contaminated scrubbing solution is treated in this step without the addition of stripping air or with only small amounts of stripping air.

Carrying out the process under vacuum prevents the stripping gas from being dissolved in the scrubbing solution or solubility from being significantly reduced. This applies to CO₂, air, oxygen and methane. The CO₂ content in the scrubbing solution can be reduced without adding air by applying the vacuum. Only very small amounts of air can be dissolved in the scrubbing solution.

By contrast, the CO₂ dissolved in the scrubbing solution can be removed only with difficulty where the process is carried out under standard pressure. Moreover, the use of air as a stripping medium is required under standard pressure which entails the risk of air dissolving in the water and dissolved air in the scrubbing column being stripped out into the biomethane.

The scrubbing solution purified in the third step in the vacuum stripper is returned to the scrubbing stage of the gas scrubber and the waste gas is released to the surroundings or utilized for other purposes.

The proposed method results in comparatively small methane losses of under 0.05%. When the system is operated under standard pressure, the energy consumption for the three purifying steps is less than 0.04 kWh/Nm³ biogas, enabling the system to be operated extremely economically. Moreover, the exhaust gas which accrues in the first stripping stage and is of fuel gas quality can be used for energy production. This is particularly important if biogas is to be used for feeding into a natural gas network or for producing fuel where no waste heat from electricity generation is available. The waste heat from a biomethane compression is not sufficient to heat the digester and in such cases additional fossil fuel must be provided. The fuel gas produced as a by-product can be put to good use to heat the digester.

Alternatively, the purified biogas drawn off from the scrubbing column to increase the methane concentration and storage capacity of the biogas in the digester can be conducted directly into the digester of the biogas plant.

Linking the method according to the invention with a biogas plant in this way enables a biogas with a significantly higher methane content to be produced in the digester and the storage capacity available for the biogas to be greatly extended. The biogas drawn off from the digester with an increased methane concentration is then available for immediate commercial exploitation without further processing.

The purified biogas (methane gas) drawn off from the scrubbing stage is already sufficiently pure for immediate further use, e.g. for feeding into natural gas networks or for operating combined heat and power plants. If natural gas of greater purity is required, the methane gas present can be increased to the required degree of purity by further processing or purifying by means of an amine scrubbing. The methane gas can be fed—either individually or with the stripping gas (fuel gas) drawn off from the first stripping column—to a further processing stage to increase the methane content. A subsequent amine scrubbing as well as the regeneration of the scrubbing solution can be carried out with significantly less expenditure of energy and significantly smaller methane losses because the major part of the impurities have already been removed from the biogas.

The fresh water is then fed to the first purifying step, the scrubbing column, at a temperature of up to 65° C., preferably under 20° C. Ground water at a temperature of 10 to 15° C. can be used as fresh water.

The lower the temperature of the scrubbing solution the greater is its capacity to remove carbon dioxide. With warm ambient temperatures, the scrubbing solution should therefore be cooled before being fed into the gas scrubber. The capacity to remove carbon dioxide dissolved in the scrubbing solution can be set via the parameters of the amount of scrubbing solution/h and the scrubbing solution temperature in the scrubbing column. A greater quantity of scrubbing solution and a lower scrubbing solution temperature lead to an increased capacity to remove carbon dioxide.

The ratio of the amount of stripping air:amount of biogas (raw gas) in the first stripping stage should be 1:50 to 1:1000, preferably 1:100. A higher methane concentration in the stripping gas (exhaust gas) is achieved with a small ratio of 1:50 than with larger ratios. At the same time, the possibility of methane slip should be borne in mind. Preferably, normal air should be used as stripping air, though oxygen and nitrogen or carbon dioxide are suitable, either individually or as a mixture.

The biogas fed in should be set to a sulfur content of <5 ppm before being conducted into the scrubbing stage or rather gas scrubber. This can be done by a desulfurization unit known per se in the digester or by means of a separate predesulfurization unit. If the sulfur content in the contaminated scrubbing solution in the scrubbing stage is too high, e.g. over 30 ppm, it may be necessary for the scrubbing solution circulated in the circuit to be partly or completely replaced by fresh water. In order to avoid this, part of the scrubbing solution drawn off from the base of the second stripping column can be removed from the circuit and a reactant that binds hydrogen sulfide, e.g. iron-III-chloride or iron-III-oxide added to said scrubbing solution, whereby the dissolved hydrogen sulfide is chemically bound and the scrubbing solution is recirculated after the precipitation of the iron (II) disulfide. Where concentrations of hydrogen sulfide in the biogas exceed 30 ppm, the gas scrubbing can be used at the same time for external desulfurization in which case a suitable desulfurization unit, e.g. a unit using biofilters, is to be positioned downstream of the stripping gas from the second stripping stage.

The proposed system for carrying out the method is of simple and inexpensive construction and is explained in greater detail below.

The drawings show the following details:

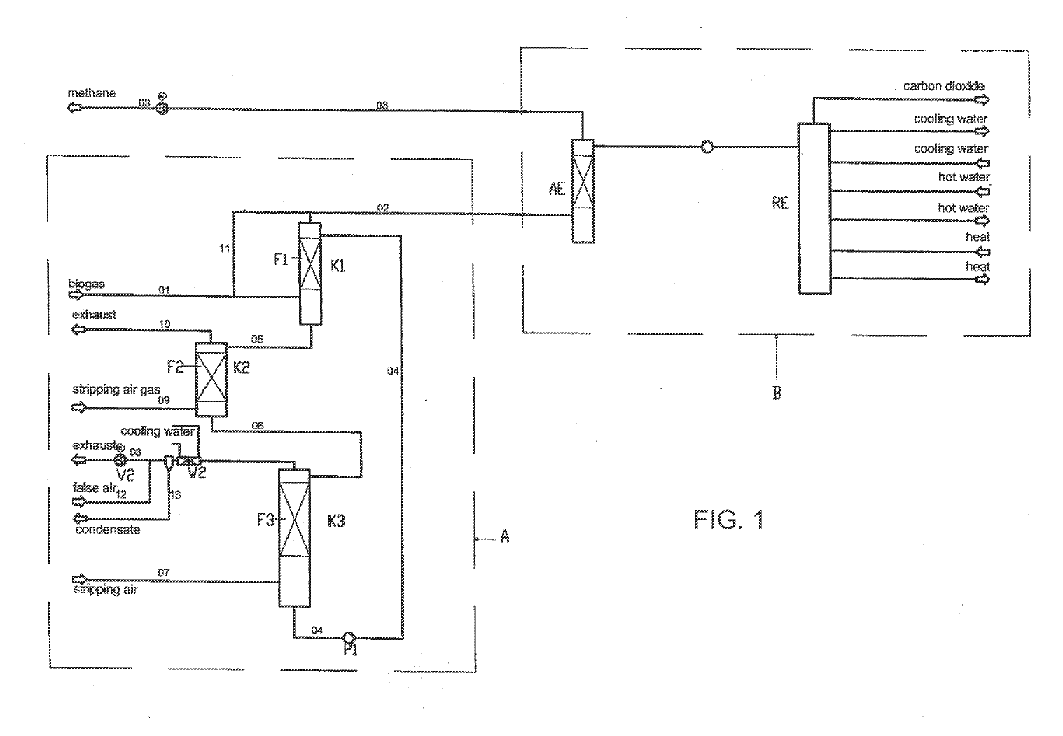

FIG. 1 an initial embodiment variant of a system for carrying out the method in simplified representation

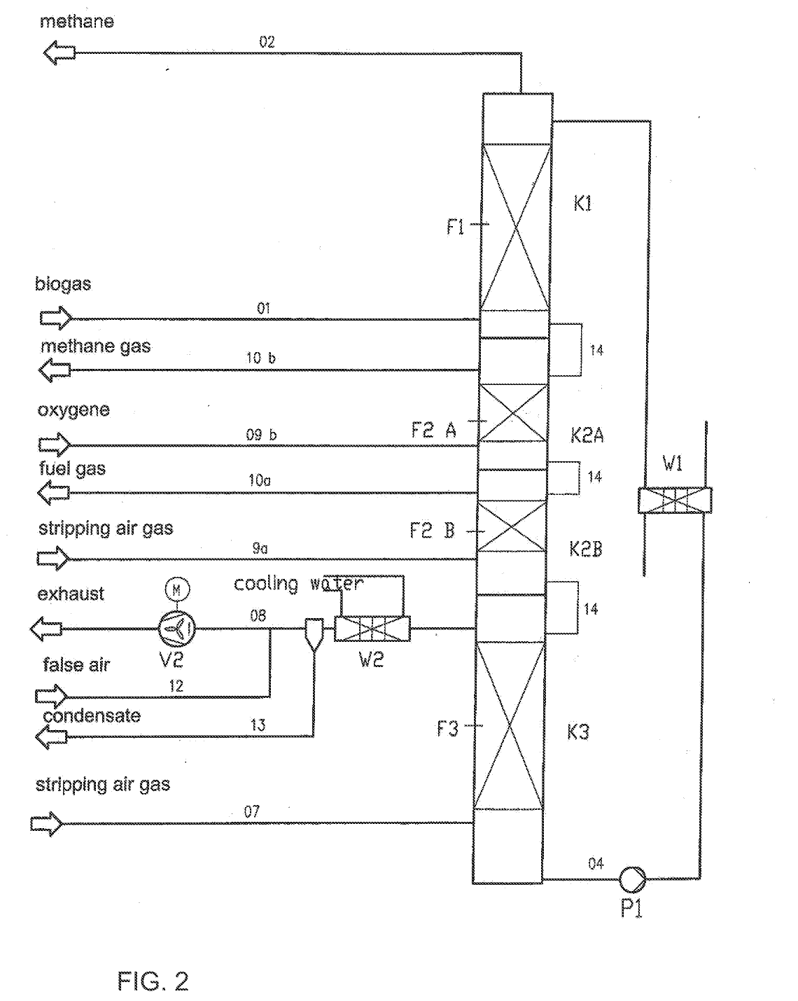

FIG. 2 a second embodiment variant of the purifying unit A in simplified representation

The system shown in FIG. 1 comprises a purifying unit A according to the invention for obtaining methane from raw gas or biogas and an optionally connectable assembly B for a subsequent amine scrubbing in a manner known per se. The main components of the assembly B for the amine scrubbing comprise an absorption unit AE for the further removal of carbon dioxide from the gas prepurified in the purifying unit A and a regeneration unit RE for regenerating the contaminated scrubbing solution accruing containing amines which is circulated in the circuit.

The purifying unit A comprises three scrubbing columns connected in series, a scrubbing column (gas scrubber) K1, a first stripping column K2 and a second stripping column K3 constructed as a vacuum column, with the components contained in the biogas (raw gas), such as carbon dioxide, sulfur compounds, ammonia and other water-soluble substances removed in the scrubbing column K1. The scrubbing column K1 comprises a scrubbing tower with a packed bed or packing F1 made of polyethylene particles with a surface area of 200 to 850 m²/m³ and a bed height of 2 to 16 m dependent on the degree of CO₂ removal required.

The first stripping column K2 and the second stripping column K3 each consist of a tower with a packed bed F2 and F3 respectively made of polyethylene particles. The first stripping column K2 contains polyethylene particles with a surface area of 250 to 900 m²/m³, preferably 300 to 790 m²/m³ and a bed height of 2 to 4 m. In the second stripping column K3 the bed height is 2 to 8 m with stain-less steel or polyethylene particles with a surface area of 100 to 480 m²/m³ used as packing. The second stripping column K3 is constructed as a vacuum stripping column and is made preferably of stainless steel.

The scrubbing columns K1, K2 and K3 are interconnected via a circulation line 05, 06, 04, with a circulation pump P1 integrated into the line 04 which circulates the scrubbing solution fed in which is drawn from a well, the local supply network or rainwater harvesting.

The biogas to be purified is fed into the scrubbing column K1 via the line 01 below the packed bed F1. The scrubbing solution is fed in at the head of the scrubbing column K1 via the line 04 and flows through the packed bed or packing F1 in counterflow to the biogas fed in. Purified biogas (methane gas) is drawn off at the head of the scrubbing column K1 via the line 02. Contaminated scrubbing solution is drawn off at the base of the scrubbing column K1 via the line 05 and fed into the first stripping column K2 at its head. A first stripping air stream enters the stripping column K2 below the packed bed F2 of said stripping column via the line 09. The stripping gas formed (exhaust gas) is drawn off at the head of the stripping column K2 via the line 10. Contaminated scrubbing solution accruing at the base of the stripping column K2 is drawn off via the line 06 and fed into the second stripping column K3 at its head.

The pressure of the scrubbing solution drawn off in line 06 is dipped to match the underpressure prevailing in the vacuum stripping column K3 so that no stripping gas from the stripping column 2 can penetrate said vacuum stripping column (0.1 bar=1 m dipping).

A second stripping gas stream (e.g. air and/or carbon dioxide) is fed in below the packed bed F3 of the vacuum stripping column K3 via the line 07. The accruing stripping gas (exhaust gas) is drawn off at the head of the vacuum stripping column K3 via the line 08 and the vacuum pump V2 integrated into said stripping column.

The vacuum required in the second stripping column K3 is produced by the vacuum pump V2. En-trained air is added to the vacuum pump V2 via the line 12 to create the vacuum required each time in the vacuum column K3. This entrained air can be preheated to prevent condensation.

In addition, a heat exchanger W2 is integrated into the line 08 in order to cool and dehumidify the stripping gas drawn off at the head of the vacuum column K3, with the condensate formed drawn off via the line 13.

The purified scrubbing solution accruing at the base of the stripping column K3 is pumped via the line 04 to the head of the first scrubbing column K1. The stripping gas and scrubbing solution in the scrubbing columns K2 and K3 are brought into contact by counterflow or if necessary by parallel flow as well (stripping column K3).

A shunt line 11 connected to the absorption unit AE can be integrated into the line 01 to feed in biogas.

The stripping processes are carried out under standard pressure (stripping column K3) and vacuum (stripping column K3).

The stripping processes are carried out under standard pressure.

If the operator requires further methane enrichment of the methane gas drawn off via the line 02, this gas can be fed to the downstream amine scrubbing unit (component B). After the amine scrubbing the high-purity methane gas is drawn off at the head of the absorption unit AE via the line 03 into which a biomethane compressor is integrated. The purifying unit A can also be operated without a subsequent amine scrubbing.

The purifying unit A shown in FIG. 2 differs from the scrubbing unit A shown in FIG. 1 only to the extent that the individual purifying steps K1 to K3 are arranged in a single-stage tower and the stripping column K2 is constructed in two parts divided into the upper column section K2A and the lower column section K2B, each of which have a packed bed F2A and F2B respectively.

Oxygen is fed to the column section K2A via the line 09b and air is fed to the column section K2B as a stripping medium via the line 09a.

If, for example, only 0.5 Nm³/h oxygen is fed to the column section K2A, 4 Nm³/h of dissolved methane is removed from the scrubbing solution. A methane gas with high oxygen content that is used as a source of oxygen for a biological desulfurization of the biogas (raw gas) is drawn off via the line 10b.

The residual methane still contained in the contaminated scrubbing solution is removed by means of air in the downstream column section K2B. The fuel gas drawn off via the line 10a is fed to a thermal utilization system.

The contaminated scrubbing solution accruing is conducted through each of four overflows 14 from the scrubbing column K1 into the first stripping column K2 and from this into the second stripping column K3 which is constructed as a vacuum column.

The separating plates arranged between the individual columns are constructed so as to be technically leakproof as regards gas loading and completely permeable as regards fluid loading. In addition, a heat exchanger W1 for cooling the scrubbing solution is integrated into the circulation line 04 downstream of the pump P1.

The mode of operation of the systems is explained below in conjunction with the examples.

### EXAMPLE 1

The biogas, which is produced by the digester of a biogas plant and has already been desulfurized in the digester without adding air or oxygen, has the following composition:

| | | |
|---|---|---|
| Methane | 52% | by volume |
| Carbon dioxide | 44% | by volume |
| Water | 3.4% | by volume |
| Hydrogen | 0.1% | by volume |
| Oxygen | 0.1% | by volume |
| Nitrogen | 0.4% | by volume |
| H₂S | 3 | ppm |
| NH₃ | 20 | ppm |

Biogas (500 Nm³/h) at a temperature of 38 to 45° C. is fed directly from the digester to the scrubbing column K1 and flows through the packed bed (height 4 m), coming into contact in the process with the scrubbing solution which is drawn from the local supply network and is circulated in the circuit and fed in a counterflow direction. Scrubbing takes place under standard pressure (−10 to +20 mbar) with 400 m³/h water fed in, based on the amount of biogas fed in. The scrubbing solution purified in the scrubbing column K1 contains 300 mg/l of CO₂. CO₂, H₂S and NH₃ are removed from the biogas during the pressureless gas scrubbing and are dissolved in the scrubbing solution. The proportion of CO₂ in the spent scrubbing solution amounts to approximately 800 mg/l. 200 kg/h CO₂ is therefore dissolved in the scrubbing solution, with the removed portion of CO₂ amounting to approximately 46.4%.

333 Nm³/h of purified biogas (methane gas) with the following composition is drawn off at the head of the scrubbing column K1:

| | | |
|---|---|---|
| Methane | 65.43% | by volume |
| Carbon dioxide | 30.44% | by volume |
| Water | 3.36% | by volume |
| Hydrogen | 0.13% | by volume |
| Oxygen | 0.13% | by volume |
| Nitrogen | 0.51% | by volume |
| H₂S | <1 | ppm |
| NH₃ | <1 | ppm |

In a subsequent second purifying step the contaminated scrubbing solution accruing at the base of the scrubbing column K1 and containing entrained methane dissolved in the scrubbing solution (so-called methane slip) is fed directly through a first stripping column K2 in which methane is partially removed from the contaminated scrubbing solution by means of stripping air fed in a counterflow direction. The stripping process in this second purifying step takes place under standard pressure. The small amount of stripping air fed in (5 Nm³/h) ensures that more than 98% of approximately 6.8 Nm³/h of the dissolved methane is removed from the contaminated scrubbing solution by the stripping air because of the conditions imposed by the design of the first stripping column (surface area of packed bed 790 m²/m³; bed height 2 m). The stripping gas (exhaust gas) drawn off at the head of the first stripping column K2 still contains CO₂ (approximately 4 Nm³/h). The stripping gas (exhaust gas) accruing has a methane content of 43% by volume and has the same quality as a fully-fledged fuel with a calorific value of 74.5 kW.

This can be used for enriching the methane gas stream drawn off from the scrubbing column K1 or used as a source of energy as a fuel or heating gas. The second purifying step therefore ensures that the overall losses of the methane from the biogas are kept to a relatively low level and do not exceed a value of 0.5%.

The contaminated, methane-free scrubbing solution accruing in the first stripping stage K2 is fed directly by a dipped supply line to a further purifying step, the vacuum stripping stage K3, in which the CO₂ is removed from the scrubbing solution in which it is dissolved because of the vacuum applied (0.5 bar).

The vacuum stripping column K3 (surface area of packed bed 480 m²/m³; bed height 2 m) is connected to a vacuum pump V2 via the line 08. Entrained air is aspirated continuously via the line 12, thereby creating the vacuum.

300 Nm³/h of hot stripping air (25° C.) is fed in which absorbs the carbon dioxide bound in the scrubbing solution. The vacuum applied prevents the stripping gas from dissolving in the scrubbing solution

The carbon dioxide loading in the scrubbing solution is reduced under these conditions from about 780 g/l to 300 mg/l. The purified scrubbing solution accruing at the base of the stripping column K3 is fed to the scrubbing column K1 by the pump P1 via the line 04.

The exhaust gas leaving the stripping column K3 can be discharged into the surroundings immediately and without any further treatment.

Only 18.5 kW of electrical energy is required for the entire process control of the three purifying steps K1, K2 and K3 which is of great importance in terms of the economical operation of the method. This low energy consumption results in a specific consumption of 0.037 kWh/Nm³ based on the input of biogas (500 Nm³/h).

The purified biogas (methane content 65.43% by volume) drawn off at the head of the scrubbing column K1 is available for immediate further commercial exploitation or can, if required, be further purified to increase its methane content.

Further purification can, for example, be carried out by an amine scrubbing that is per se known, as described for example in the published documents DE 10 200 051 952 B3 and WO 2008/034473 A1. After the methane gas drawn off at the head of the scrubbing column K1 has been purified by means of an amine scrubbing with a scrubbing agent containing amines, a purified biogas (methane gas) with the following composition is produced:

| | | |
|---|---|---|
| Methane | 88.3% | by volume |
| Carbon dioxide | 0.3% | by volume |
| Water | 10.3% | by volume |
| Hydrogen | 0.17% | by volume |
| Oxygen | 0.17% | by volume |
| Nitrogen | 0.69% | by volume |
| H₂S | 2 | ppm |
| NH₃ | 1 | ppm |

After the water still contained in the biogas has been removed in a downstream dehumidification stage and the purified biogas set to a dew point temperature of 2° C., the biogas has the following composition:

| | | |
|---|---|---|
| Methane | 97.7% | by volume |
| Carbon dioxide | 0.38% | by volume |
| Water | 0.78% | by volume |
| Hydrogen | 0.19% | by volume |
| Oxygen | 0.19% | by volume |
| Nitrogen | 0.76% | by volume |
| H₂S | 2 | ppm |
| NH₃ | 1 | ppm |

The methane content can be increased still further by further cooling and removal of the residual water content and/or reduction of the nitrogen content. This will not, however, be necessary for most technical areas of applications of the purified biogas (methane gas).

A subsequent amine scrubbing (with scrubbing solution regeneration) can be carried out with considerably less energy expenditure than is otherwise necessary for purifying biogas as a raw gas because only small amounts of impurities still need to be removed, as the biogas has already been prepurified in the purifying steps K1 to K3.

The thermal energy required for purifying the scrubbing solution containing amines is therefore reduced from 250 kW to 143 kW. Accordingly, the specific heat requirement based on the amount of biogas can be reduced from 0.5 to 0.268 kWh/Nm³. A further advantage is the low methane loss (0.03%) compared with conventional amine scrubbing (0.1%). Of the 143 kW used for the amine scrubbing approximately 85% of thermal energy can be made available again by waste heat recovery for further utilization. This can be used to heat the digester to a temperature of 58° C. The loading of the scrubbing agent can be increased from 800 mg/l to 1,200 g/l by increasing the height of the packed bed or height of the packing in the scrubbing column K1. The amount of CO₂ removed can therefore be increased from 46.4% to 83.5%. Furthermore, by applying a vacuum of 0.3 instead of 0.5 bar in the stripping column K3, the loading of CO₂ in the scrubbing agent can be reduced from 300 to under 200 mg/l which also leads to a higher rate of CO₂ removal. The CO₂ content in the scrubbing solution can be reduced to below 50 mg/l by feeding an additional small amount of stripping air of 1 to 2 Nm³/h into the vacuum stripping column K3 via line 07.

### EXAMPLE 2

A biogas is formed in a hydrolysis stage of a biogas plant at an amount of 300 Nm³/h and is treated in a similar way to Example 1.

| | | |
|---|---|---|
| Methane | 10.4% | by volume |
| Carbon dioxide | 85.0% | by volume |
| Water | 4.5% | by volume |
| Hydrogen | 0.0% | by volume |
| Oxygen | 0.1% | by volume |
| Nitrogen | 0.3% | by volume |
| H₂S | 500 | ppm |
| NH₃ | 5 | ppm |

Input amount: 300 Nm³/h, temperature from 38 to 45° C.;

### Gas Scrubbing Column K1

Surface area of the packed bed: 320 m²/m³
Standard pressure; amount of scrubbing solution: 300 m³/h
Composition of the purified biogas (methane gas) drawn off at the head of the scrubbing column K1 at an amount of 139 Nm³/h:

| | | |
|---|---|---|
| Methane | 21.58% | by volume |
| Carbon dioxide | 73.38% | by volume |
| Water | 4.17% | by volume |
| Hydrogen | 0.0% | by volume |
| Oxygen | 0.22% | by volume |
| Nitrogen | 0.65% | by volume |
| H₂S | <10 | ppm |
| NH₃ | <1 | ppm |

### Stripping Column K2:

Surface area of the packed bed: 840 m²/m³
Amount of stripping air fed in: 0.1 Nm³/h;
0.3 Nm³/h of dissolved methane (=99.7%) is removed from the contaminated scrubbing solution
Stripping gas (exhaust gas) drawn off contains 0.5 Nm³/h CO₂, water vapor according to saturation and 0.05 by volume of H₂S;
Methane content of the stripping gas (fuel gas): 31.0% by volume;
Calorific value of the stripping gas (fuel gas): 3.3 kW

### Vacuum Stripping Column K3:

Surface area of the packed bed: 220 m²/m³
Vacuum applied 0.1 bar;
Amount of stripping air 5 m³/h
CO₂ loading reduced from 1200 g/l to 200 mg/l

The ratio of the packed bed heights of the columns: K1:K2:K3 is 4:1:1

### Energy Consumption K1 to K3

Electrical energy: 14.5 kW
Specific energy consumption: 0.048 kWh/Nm³
Methane losses amount to only 0.2%

The biogas (methane content 21.58 by volume) prepared in this way has only 46.3% of the original biogas volume but a 60% smaller proportion of CO₂, which leads in the subsequent biogas production with methanation in the digesters to a biogas with an overall methane content of 70% by volume which can then be suitably prepared in a similar way.

1-21. (canceled)

22. A method of purifying a raw gas, including a biogas, for obtaining methane and components contained in the raw gas such as carbon dioxide, sulfur compounds, ammonia and other water-soluble substances, are removed in a multi-stage purification process, which comprises the steps of:
carrying out the multi-stage purification process in at least three purifying steps taking place in immediate succession to each other and using additive-free fresh water circulated in a circuit, the carrying out step including:
performing a first purifying step where the raw gas to be purified and drawn off from a plant flows through a scrubbing column having a packed bed under a pressure ranging from a standard pressure to an overpressure of up to 6 bar in counterflow to the fresh water fed in and the carbon dioxide, hydrogen sulfide, the ammonia and other organic water-soluble substances contained in the raw gas are bound in the fresh water, and drawing off the methane gas with a methane content of at least 60% at a head of the scrubbing column;
performing a second purifying step by dissolving the methane in a contaminated scrubbing solution drawn off from the scrubbing column and is at least 90% removed under standard pressure on a counterflow principle at temperatures of up to 80° C. in a first stripping column having one of a packed bed, a packing with stripping air or stripping air and oxygen, or packing with stripping air and carbon dioxide fed in, either singly or in combination, at an amount of 0.1% to 20% based on an amount of the gas fed in, with an oxygenic stripping gas of a fuel gas quality being produced in the process; and
performing a third purifying step by removing the carbon dioxide dissolved in the contaminated scrubbing solution drawn off from the first stripping column to a residual content of under 300 mg/l in a second stripping column having one of a packed body or packing under a vacuum in parallel or counterflow to stripping air, a purified scrubbing solution being fed to the scrubbing column and an exhaust gas is drawn off.

23. The method according to claim 22, which further comprises setting a temperature of the fresh water circulated in the circuit at up to 65° C.

24. The method according to claim 22, which further comprises returning a stripping gas drawn off in the first purifying step from the first stripping column (K2) to either a digester of a biogas plant or fed to a methane gas stream removed in the scrubbing column or used as a fuel gas.

25. The method according to claim 22, wherein in the second purifying step, the first stripping column for removing the methane from the contaminated scrubbing solution is constructed as a two-stage column, with oxygen fed in a first stage and the stripping air fed in a second stage, or vice versa, and two different fuel gases with different oxygen contents are produced.

26. The method according to claim 25, which further comprising using a fuel gas with a high oxygen content as a source of oxygen for a biological desulfurization of the raw gas being a biogas.

27. The method according to claim 22, which further comprises feeding the methane gas drawn off in the scrubbing column to a further processing stage to increase methane content either individually or together with a stripping gas drawn off from the first stripping column.

28. The method according to claim 22, which further comprises setting a sulfur content of the raw gas fed in to be <5 ppm before the raw gas is fed into the scrubbing column.

29. The method according to claim 22, wherein a scrubbing solution circulating in the circuit is at least partly replaced by fresh water after a specified period of operation if a sulfur content in the contaminated scrubbing solution drawn off from scrubbing column has risen to a level above 50 ppm.

30. The method according to claim 22, which further comprises:
removing a partial amount of scrubbing solution drawn off at a base of the second stripping column from the circuit;
adding a reactant that binds hydrogen sulfide to the scrubbing solution; and
returning the scrubbing solution to the circuit after precipitation of iron (II) disulfide.

31. The method according to claim 22, wherein a capacity to remove the carbon dioxide dissolved in the scrubbing solution can be set by means of parameters of an amount of scrubbing solution/h and a scrubbing solution temperature in the scrubbing column, with a greater amount of scrubbing solution and a lower scrubbing solution temperature leading to a greater capacity to remove the carbon dioxide.

32. The method according to claim 22, wherein purified raw gas drawn off from the scrubbing column to increase a methane concentration and a storage capacity of the biogas in a digester is fed directly to a digester of the biogas plant.

33. The method according to claim 22, which further comprises feeding entrained air to a vacuum pump in the second stripping column to create a vacuum in the third purifying step.

34. The method according to claim 33, which further comprises preheating the entrained air fed to the vacuum pump.

35. The method according to claim 22, which further comprises feeding the carbon dioxide gas exiting the second stripping column to a condensation stage in which water contained in the carbon dioxide gas is condensed at a partial pressure of under 100 mbar.

36. A system for purifying raw gas, including a biogas, for obtaining methane, the system comprising:
a scrubbing column constructed as a gas scrubber for removing by means of a scrubbing solution components contained in the raw gas including carbon dioxide, sulfur compounds, ammonia and other water-soluble substances, said scrubbing column having a head and one of a packed bed or packing with a surface area of 300 to 900 mm²/m³ and a bed height of 2 to 16 m;
a first stripping column for removing the methane dissolved in contaminated scrubbing solution, said first stripping column having a base and one of a packed bed or packing with a surface area of 350 to 900 mm²/m³ and a bed height of 1 to 4 m;
a second stripping column constructed as a vacuum column for removing the carbon dioxide from the contaminated scrubbing solution accruing at said base of said first stripping column, said second stripping column having a base and one of a packed bed or packing with a surface area of 100 to 300 mm²/m³ and a bed height of 1 to 10 m;
a circulation line carrying the scrubbing solution, said base of said second stripping column connected to said head of said scrubbing column by said circulation line;
a pump integrated into said circulation line; and
said scrubbing column and said first and second two stripping columns connected in series.

37. The system according to claim 36, further comprising a heat exchanger integrated into said circulation line to cool the scrubbing solution.

38. The system according to claim 36, wherein said scrubbing column and said first and second stripping columns have a same column diameter and different packed bed heights, with ratios of said bed heights in said scrubbing column:said first stripping column:said second stripping column being 3:1:2 to 3:0.5:1.

39. The system according to claim 36, wherein a ratio of surface areas of said packed beds in said first stripping column:said second stripping column is 1:0.2 to 1:0.8.

40. The system according to claim 36, wherein said first stripping column is divided into an upper column section and a lower column section each fitted with said packed bed or said packing, said upper column section is connected to a line feeding in oxygen and said lower column section is connected to a line feeding in air.

41. The system according to claim 36, further comprising a tower, said scrubbing column and said first and second stripping columns are disposed in said tower.

42. The system according to claim 36, wherein said scrubbing column and said first and second stripping columns having separating plates constructed so as to be technically leakproof as regards gas loading and completely permeable as regards fluid loading.

43. The system according to claim 36, wherein a ratio of surface areas of said packed beds in said first stripping column:said second stripping column is 1:0.5.
